(19) United States
(12) Patent Application Publication
(10) Pub. No.: US 2016/0319956 A1
(43) Pub. Date: Nov. 3, 2016

(54) SHUT OFF VALVE CONSTRUCTION

(71) Applicant: Michael Agnes, Wethersfield, CT (US)

(72) Inventor: Michael Agnes, Wethersfield, CT (US)

(21) Appl. No.: 14/699,473

(22) Filed: Apr. 29, 2015

(51) Int. Cl. F16K 31/60; E03C 1/02

(52) U.S. Cl. CPC F16K 31/60; E03C 1/02

(57) ABSTRACT

One form of the apparatus in accordance with the present invention includes a valve which comprises a body having an inlet port having a first geometric axis and an outlet port having a second geometric axis, the first geometric axis being disposed in coplanar relationship with the second geometric axis with an included angle therebetween of 90°. The inlet and the outlet are selectively in fluid communication or not in fluid communication therebetween. The apparatus includes a shaft carried for rotational movement with respect to the body to permit an operator to selectively to allow or not allow fluid communication between the inlet and the outlet; the shaft has a third geometric axis and the third geometric axis is congruent with the first geometric axis. The apparatus also includes a knob carried on the, shaft having a maximum radius X.

### CROSS-REFERENCE TO RELATED APPLICATIONS

### Technical Field

The present invention is generally directed to plumbing apparatus. More particularly, the present invention is directed to valves. Even more particularly, the present invention is directed to shut off valves such as those commonly provided under a sink. Typically such valves are provided in both the hot and cold water pipes supplying respective hot and cold water faucets or a single centerset faucet. Usually a braided stainless steel flexible connector is provided between the shut off valve and the faucet. The shut off valves are essential to allow replacement of the associated faucet or replacement of the associated faucet washer.

### BACKGROUND OF THE INVENTION

Angle stop shut off valves are known in the art. U.S. Pat. No. 5,653,254 and United States patent application 2005/0151106 describe such angle stop shut off valves.

The present invention has particular application to angle stop shut off valves. Such valves are usually used for connecting water supply lines for the fixture, such as a sink or a toilet. Such valves are useful to avoid having to turn off the water to the entire house just to perform simple maintenance such as to fix a leaky faucet. Such valves will allow you to shut off the water to one sink without disrupting the flow to others as well as to provide a quick way to turn off the water in the event of a flood caused by, for instance, a crack fitting or ruptured supply tube. Angle stop shut off valves typically have the axis of an inlet that is coaxial with the center of rotation of a handle and an outlet having a geometric axis that is disposed at a right angle with respect the geometric axis of the inlet.

A prior art shut off valve is shown in FIG. 1. Such valves are widely sold and include valves marketed by BrassCraft Manufacturing Company of Novi, Mich. 48375 as well as other entities. U.S. Pat. No. 5,653,254 describes one such valve. In the particular valve illustrated the fitting on the left as viewed is a sweat fitting and is the inlet. The outlet of the valve is located at the top as viewed. The outlet fitting is a compression fitting using a lock nut and a ferrule (not shown) to secure what is typically a flexible fluid conduit that extends from the shut off valve to the faucet. The handle has a elliptial shape or oval-shape.

Typically each shut off valve is installed under a sink in a very inaccessible location. More particularly the space under the sink is typically confined by an enclosure. The nature of the space confinement has even been the subject of numerous cartoons and pictures focusing on the contortions required of plumbers to access this particular area.

In a typical scenario a plumber is attempting to make a connection to the outlet by means of the lock nut on the top fitting while the water pressure is in the inlet connection and the valve is closed. The angular position of the handle is thus dependent on the seating of the valve so that there is no flow through the valve and out the outlet. Frequently, the maximum dimension of the handle will be aligned with the geometric axis of the outlet. It will be understood from FIG. 1 that a typical open end wrench (not shown) will engage the lock nut and extend in a direction that is perpendicular the geometric axis of the lock nut. It is thus readily apparent that there is a substantial interference with the handle. Although the handle may be secured by a screw the confined location even makes it difficult to remove the handle while the connection is made to the outlet port of the valve and then reattaching the handle afterwards.

Accordingly, the plumber working on a connection to the outlet has the perfect storm of a confined work place and the interference of the maximum dimension of the handle. From the above, it is therefore seen that there exists a need in the art to overcome the deficiencies and limitations described herein and above.

### SUMMARY OF THE INVENTION

The shortcomings of the prior art are overcome and additional advantages are provided in one form of the apparatus in accordance with the present invention includes a valve which comprises a body having an inlet port having a first geometric axis and an outlet port having a second geometric axis, the first geometric axis being disposed in coplanar relationship with the second geometric axis with an included angle therebetween of 90°. The inlet and the outlet are selectively in fluid communication or not in fluid communication therebetween. The apparatus includes a shaft carried for rotational movement with respect to the body to permit an operator to selectively to allow or not allow fluid communication between the inlet and the outlet; the shaft has a third geometric axis and the third geometric axis is congruent with the first geometric axis. The apparatus also includes a knob carried on the, shaft having a maximum radius X.

The outlet has a free end, the free end has threads for engaging an associated lock nut. Substantially all the threads on the free end thereof are disposed a distance from the first geometric axis whereby substantially all of the threads for engaging the associated lock nut are disposed at a distance from the first geometric axis that is greater than X.

In some forms of the invention the handle has at least a first set of two opposed flat surfaces dimensioned and configured for engagement with a wrench. Other embodiments include at least a second set two other opposed flat surfaces dimensioned and configured for engagement with a wrench. The handle may have sequential peripheral portions thereof which are one of the first set of opposed flat surfaces, an arcuate surface, one of the second set of opposed flat surfaces, an arcuate surface, the second of the first set of opposed flat surfaces, an arcuate surface, the second of the second set of opposed flat surfaces and an arcuate surface.

Each of the flat surfaces may be coincident with at least parts of a regular octagon. The handle may have a geometric center and the distance between the geometric center and the periphery of the handle may be less than X.

Accordingly, it is an object of the present invention to provide a shut off valve apparatus that will facilitate easier and faster installation of a shut off valve.

It is another object of the present invention to provide a shut off valve apparatus that will not materially change the cost of known shut off valves.

It is yet another object of the present invention to provide a shut off valve that will enable plumbers to install the valve despite space limitations.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a side view of a prior art shut off valve,

FIG. 2 is a side view of a shut off valve in accordance with one form of the present invention,

FIG. 3 is a front view of a valve handle in accordance with one form of the present invention,

### DETAILED DESCRIPTION

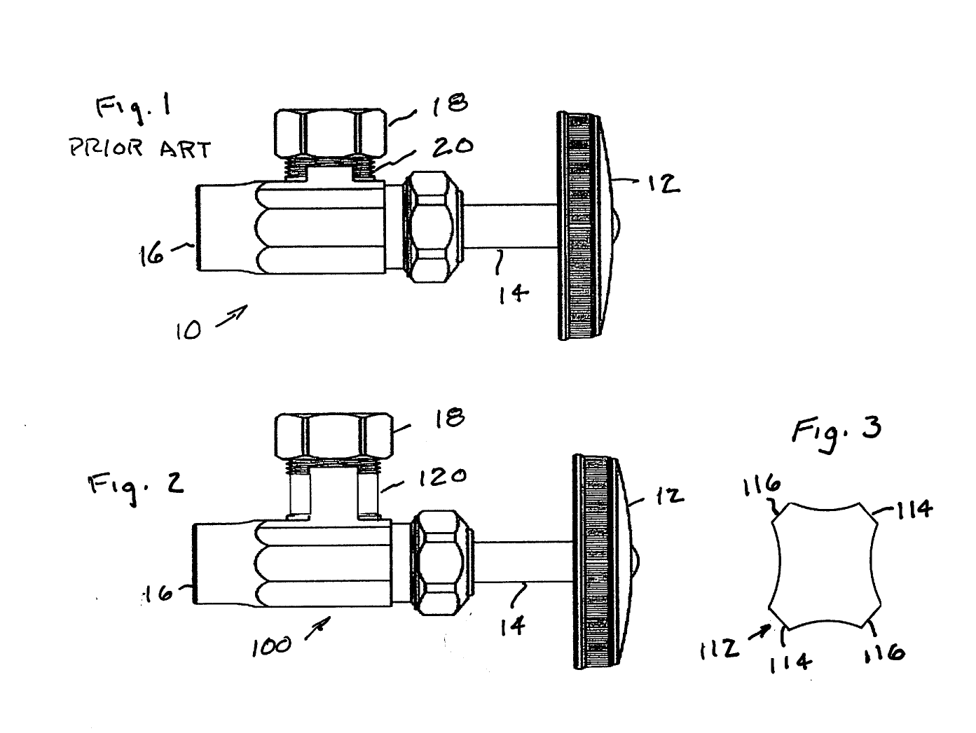

A prior art shut off valve 10 is shown in FIG. 1. In this particular valve the fitting on the left as viewed is a sweat fitting and is the inlet 16. The outlet of the valve is located at the top as viewed. The outlet fitting includes a lock nut 18 that is part of a compression fitting using the lock nut 18 and a ferrule (not shown) to secure what is typically a flexible fluid conduit (not shown) that extends from the shut off valve to the faucet (not shown). The handle 12 has an elliptical or oval-shape. The outlet fitting 18 includes a neck 20 that is integrally formed with the body of the valve. As best seen in FIG. 1 a plane defined by the top of the lock nut 18 as well as a plane defined by the bottom of the lock nut 18 will extend through the handle 12. Thus, when a plumber engages the lock nut in the embodiment shown in FIG. 1 with an open and wrench the handle of the wrench will interfere with the handle 12 of the valve. It is this interference as well as the confined spaces underneath the typical sink that severely complicates the installation of such shut off valves.

One embodiment 100 of the present invention shown in FIG. 2 differs from the prior art apparatus shown in FIG. 1 with respect to the length of the neck 120. As best seen in FIG. 2 a plane defined by the top of the lock nut 118 as well as a plane defined by the bottom of the lock nut 118 will not extend through the handle 12. Accordingly, a typical open end wrench can engage opposed flat surfaces on the lock nut 118 and not interfere with the handle 12. Accordingly the plumber utilizing the shut off valve 100 is much better able to quickly and easily accomplish the required task. Unlike the embodiment illustrated in FIG. 1 the plumber can easily connect with an open end wrench to the lock nut 18 in the embodiment of FIG. 2. Thus, a substantial difference in utility is achieved by increasing the length of the neck 112 and more specifically increasing the length whereby substantially all of the threads located at the upper (as viewed) axial extremity of the neck 112 are disposed at a higher elevation than the maximum elevation of the handle 12.

An alternative approach to the interference problem between a wrench engaging the lock nut 18 and the valve handle 12 requires a change in the contours of the valve handle. As best seen in FIG. 3 an alternative handle 112 having a much more compact shape and size. A preferred form of the handle includes a peripheral surface that includes a first set of two opposed rectilinear sides 114 that are coextensive with a virtual octagon in addition to a second set of two opposed rectilinear sides 116 that are coextensive with the same virtual octagon. The peripheral surface includes an arc-shaped portion intermediate adjacent rectilinear sides 114 and 116. Accordingly as shown in FIG. 3 successive portions of the peripheral surface starting at the top most part of the handle 112 are an arc shaped portion, a rectilinear side 114, an arc shaped portion, a rectilinear side 116, an arc shaped portion, a rectilinear side 114, an arc shaped portion, and finally a rectilinear side 116.

Because the handle 112 is adapted to be engaged by a wrench the maximum dimension of the handle 112 shown in FIG. 3 can be much smaller than in the handle 12. This follows because the torque necessary to operate the valve 10 with the handle 12 is limited by the mechanical advantage provided for the operator. Thus a large diameter handle 12 can be more easily rotated manually by an operator and a small diameter handle is much more difficult to rotate manually by an operator. With the configuration illustrated in FIG. 3 the handle 112 can be much smaller and the plumber or other operator can use a wrench having a finite length that increases the mechanical advantage available to rotate the valve stem 14 and open or close the valve 100.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A valve which comprises:
a body having an inlet port having a first geometric axis and an outlet port having a second geometric axis, said first geometric axis being disposed in coplanar relationship with said second geometric axis with an included angle there between of 90°;
said inlet and said outlet being selectively in fluid communication or not in fluid communication there between;
a shaft carried for rotational movement with respect to said body to permit an operator to selectively to allow or not allow fluid communication between said inlet and said outlet, said shaft having a third geometric axis, said third geometric axis is congruent with said first geometric axis;
a knob carried on said shaft, said knob having a maximum radius X;
said outlet having a free end, said free end having threads for engaging an associated lock nut, substantially all of said threads on said free end thereof being disposed a distance from said first geometric axis whereby substantially all of said threads for engaging an associated lock nut are disposed at a distance from said first geometric axis that is greater than X.

2. A valve as described in claim 1 wherein said handle has at least a first set of two opposed flat surfaces dimensioned and configured for engagement with a wrench.

3. A valve as described in claim 2 wherein said handle has at least a second set two other opposed flat surfaces dimensioned and configured for engagement with a wrench.

4. A valve as described in claim 3 wherein said handle has sequential peripheral portions thereof which are one of said first set of opposed flat surfaces, an arcuate surface, one of said second set of opposed flat surfaces, an arcuate surface, the second of said first set of opposed flat surfaces, an arcuate surface, the second of said second set of opposed flat surfaces and an arcuate surface.

5. A valve as described in claim 4 wherein each of said flat surfaces is coincident with at least parts of a regular octagon.

6. A valve as described in claim 5 wherein said handle has a geometric center and the distance between said geometric center and the periphery of said handle is less than X.
